(19) United States
(12) Patent Application Publication
(10) Pub. No.: US 2008/0092213 A1
(43) Pub. Date: Apr. 17, 2008

(54) METHOD, SYSTEM AND SERVER FOR REALIZING SECURE ASSIGNMENT OF DHCP ADDRESS

(75) Inventors: Jiahong Wei, Shenzhen (CN); Jun Li, Shenzhen (CN); Wumao Chen, Shenzhen (CN)

Correspondence Address: LADAS & PARRY, 5670 WILSHIRE BOULEVARD, SUITE 2100, LOS ANGELES, CA, 90036-5679, US

(73) Assignee: Huawei Technologies Co., LTD., Shenzhen (CN)

(21) Appl. No.: 11/926,729

(22) Filed: Oct. 29, 2007

Related U.S. Application Data
(63) Continuation of application No. PCT/CN2006/000833, filed on Apr. 28, 2006.

(30) Foreign Application Priority Data
Apr. 29, 2005 (CN) 200510069417.4

(51) Int. Cl. G06F 21/20

(52) U.S. Cl. 726/4

(57) ABSTRACT

A method, a system and an authentication server for realizing a secure assignment of a DHCP address are disclosed. The method includes: sending a DHCP Discovery message via an access network; obtaining the identification information of the DHCP client and performing an authenticating to the DHCP client based on the identification information; and only assigning the address to the DHCP client has passed the authentication. Therefore, in the present invention, access authentication may be performed on a subscriber according to location information, and IP address is only assigned to the valid subscriber and terminal. Therefore, the security of the address assignment in DHCP mode may be enhanced greatly. Moreover, in the present invention, addresses may be managed by an AAA server unitedly, or the addresses may be assigned after being authenticated by the AAA server successfully.

### FIELD OF THE INVENTION

The present invention relates to the technical field of network communications, in particular, to a method, a system and a server for realizing a secure assignment of a Dynamic Host Configuration Protocol (DHCP) address.

### BACKGROUND OF THE INVENTION

As access technologies such as ADSL (Asymmetrical Digital Subscriber Line), Ethernet become more and more mature, broadband access becomes more and more popular; and IPTV (Internet Protocol Television) video and VoIP (Voice over Internet protocol) services developed based on broadband access network become more and more abundant. The development of each service needs to employ a dedicated terminal; for example, video service needs to use STB (Set Top Box), voice service needs to use IAD (Integrated Access Device). Each dedicated terminal needs to obtain a local address before a service is carried out, and then each service may be carried out using the local address.

In a communication network, each terminal usually obtains an IP (Internet Protocol) address based on DHCP protocol. However, in a traditional online service, PPPoE (Point-to-Point Protocol over Ethernet) is usually employed, and an AAA (Authentication, Authorization and Accounting) server is needed to authenticate an access subscriber and assign the IP address. Usually, The AAA server may be an RADIUS (Remote Authentication Dial In User Service) server or other authentication servers.

FIG. 1 shows a structure of a network communication system in which an authentication is performed by an RADIUS server and the IP address is obtained via a DHCP server.

DHCP server is a server for managing IP addresses and is adapted to respond to an address assignment request from a computer and assign an appropriate IP address to the computer.

DHCP client is a terminal adapted to obtain network parameters such as the IP address using DHCP protocol, including computer, STB and IAD.

RADIUS server is adapted to manage the account and password of a subscriber and perform an authentication to an access subscriber.

BRAS (Broadband Remote Access Server) is adapted to manage the access of a broadband subscriber; for a PPPoE subscriber, the BRAS acts as an RADIUS client and initiates an authentication request to the RADIUS server; and for a DHCP subscriber, the BRAS implements the DHCP relay function.

Access Network is an intermediate network between the subscriber household and the BRAS.

Access Node is a device connecting with a subscriber line directly in an access network, such as ADSL access device DSLAM (Digital Subscriber Line Access Multiplexer).

OSS (Operations Support Systems) is a system for the operator to release and manage a service.

In FIG. 1, a DHCP client such as STB and IAD may be assigned with a corresponding IP address using DHCP protocol by a DHCP server disposed in the network.

The specific process in which each DHCP client of FIG. 1 obtains the address is as shown in FIG. 2, including the following steps.

Step 21: A DHCP client switches on, sends a DHCP Discovery message to search a server capable of providing the DHCP service.

Step 22: As a DHCP relay, a BRAS relays the DHCP Discovery message to the designated DHCP server.

Step 23: The DHCP server returns a DHCP Offer message to indicate that the DHCP server is capable of assigning an IP address to the client.

Step 24: The DHCP client sends a DHCP Request message and the BRAS relays the DHCP request message to the DHCP server.

Step 25: The DHCP server assigns an appropriate IP address and returns a DHCP Reply message.

Therefore, the DHCP client may obtain the IP address, and thus access the network and obtain the network service.

It can be seen from the above DHCP address assignment process that: during the process in which the DHCP client obtains the IP address in a DHCP mode, an invalid subscriber may easily obtain the corresponding IP address and thus obtain the network service. Therefore, the problem that a hacker maliciously uses up the IP address resources and attacks a network is easy to occur. Moreover, after the hacker attacks the network, the hacker cannot be traced.

Additionally, the operator needs to use a DHCP server to manage the IP address of the user of the DHCP client and use an RADIUS server to manage the IP address of the user of the PPPoE client. As a result, there exists two sets of IP address resource management mechanisms, the data is decentralized, and the management cost is high.

### SUMMARY OF THE INVENTION

In view of the above problems in the prior art, an object of the present invention is to provide a method, a system and a server for realizing a secure assignment of a DHCP address. And therefore the security of the address assignment process of the DHCP server may be effectively guaranteed.

The object of the present invention is realized by the following technical solutions.

The present invention provides a method for realizing a secure assignment of DHCP address, including:

A. sending, by a DHCP client, a DHCP Discovery message via an access network;

B. obtaining, by the access network side, identification information of the DHCP client and performing an authentication to the DHCP client based on the identification information; and

C. assigning, by a DHCP server, address to the DHCP client has passed the authentication.

The identification information includes:

a port number, a circuit number and a connection number of the DHCP client.

The step B includes:

determining, by an access node or an access server in the access network, the identification information according to ingress port/circuit/connection information of the DHCP Discovery message.

The step B includes:

performing, by the access node or the access server in the access network, a validity authentication to the client according to the identification information of the DHCP client and preconfigured identification information for a valid subscriber.

The step B includes:

B1. initiating, by the access node or the access server in the access network, an authentication request to the authentication server using the identification information of the client; and

B2. performing, by the authentication server, the validity authentication to the client according to the identification information saved for the valid subscriber.

The present invention further provides a DHCP authentication server for realizing a secure assignment of DHCP address, including:

a DHCP server module, adapted to receive a DHCP request message sent by a DHCP client via an access node or an access server and reply to the DHCP client with address assigned to a client has passed an authentication, the address being returned by an AAA server and received by an AAA client module;

a protocol converting module, adapted to obtain information needed in AAA authentication in a DHCP Discovery message of a corresponding DHCP client sent from the access node or the access server, generate an AAA authentication message, generate a DHCP Offer message according to an authentication response message received by the AAA client module and send the DHCP Offer message; and

the AAA client module, adapted to communicate with the AAA server based on the AAA authentication message generated by the DHCP protocol converting module, obtain an authentication result on the DHCP client, and deliver the authentication result to the protocol converting module and the DHCP server module.

The present invention further provides a DHCP authentication server for realizing a secure assignment of DHCP address, including:

an authentication processing module, adapted to obtain identification information of a client initiating a DHCP process, perform a validity authentication to the client according to identification information saved for a valid subscriber, and send a DHCP Discovery message of the DHCP client has passed the validity authentication to the DHCP server; and

a DHCP server, adapted to receive the DHCP Discovery message sent by the authentication processing module and send a DHCP Offer message to the DHCP client, and assign an address to a corresponding DHCP client in an address pool of the DHCP server when the DHCP client sends a DHCP request message.

The present invention further provides a system for realizing a secure assignment of DHCP address, including a DHCP client, an access network and a DHCP authentication server; the DHCP client is adapted to communicate with the DHCP authentication server via an access network to obtain an address; the DHCP authentication server is adapted to perform a validity authentication to a DHCP Discovery message of the DHCP client obtained by the access network, and assign an address to the DHCP client has passed the validity authentication.

The present invention further provides a method for realizing a secure assignment of DHCP address based on above system, including:

C. receiving, by an access node or an access server, a DHCP Discovery message sent from a DHCP client, and inserting identification information of the client into the DHCP Discovery message and sending the DHCP Discovery message to a DHCP authentication server;

D. obtaining, by the DHCP authentication server, the identification information of the client from the DHCP Discovery message; and;

E. performing, by the DHCP authentication server, a validity authentication to the client using the identification information, and only performing an address assignment process on the client has passed the validity authentication.

The step E includes:

performing, by the DHCP authentication server, the authentication to the DHCP client locally according to identification information saved for a valid subscriber, and sending the DHCP Discovery message of the client has passed the authentication for a DHCP server; and performing, by the DHCP server, an address assignment process.

The present invention further provides a method for realizing a secure assignment of DHCP address, including:

F. receiving, by an access node or an access server, a DHCP Discovery message sent from a DHCP client, and inserting identification information of the client into the DHCP Discovery message and sending the DHCP Discovery message to an DHCP authentication server;

G. obtaining, by the DHCP authentication server, the identification information of the client from the message;

H. sending, by the DHCP authentication server, an authentication request message to an AAA server using the identification information, and performing, by the AAA server, an authentication to the identification information of the client and assigning address to the client has passed the authentication;

or,

sending, by the DHCP authentication server, the authentication request message to the AAA server using the identification information, and performing, by the AAA server, an authentication to the identification information of the client; assigning, by the DHCP authentication server, the address to the client has passed the authentication after receiving an authentication pass information.

It can be seen from the above technical solutions of the present invention that, in the present invention, an access authentication may be performed on a subscriber according to location information, and IP addresses are only assigned to a valid subscriber or a valid terminal. Therefore, the security of address assignment in a DHCP mode may be enhanced greatly.

Moreover, in the present invention, addresses may be managed by an RADIUS server unitedly, in other words, the DHCP server and the RADIUS server unitedly manages the IP addresses, thus the cost of network management may be lowered. In addition, the original security measures of the RADIUS server may be used to control the number of IP addresses to be obtained by a subscriber, so that the attack of malicious address use-up may be effectively prevented. Even if the network attack or other network security problems occur, the physical location of the subscriber may be traced according to the IP address, so that a hacker may be effectively deterred from carrying out an attack activity.

The present invention has good compatibility, in other words, during the implementation of the present invention, no extra interface and command is added to the OSS system, and the service management process on the user of the DHCP client is consistent with the original service release management process on the PPPoE client. As a result, the investment of the operator may be protected.

### BRIEF DESCRIPTION OF THE DRAWINGS

FIG. 1 is a structural representation of a broadband access system;

FIG. 2 is a schematic diagram showing a process in which a DHCP server obtains an address;

FIG. 3 is a structural representation of the DHCP authentication server according to the present invention;

FIG. 4 is another structural representation of the DHCP authentication server according to the present invention;

FIG. 5 is a structural representation of a system according to the present invention;

FIG. 6 is a schematic diagram of a DHCP address assignment process based on the system shown in FIG. 5;

FIG. 7 is schematic diagram of another DHCP address assignment process based on the system shown in FIG. 5;

FIG. 8 is another structural representation system according to the present invention; and

FIG. 9 is a schematic diagram of a DHCP address assignment process based on the system shown in FIG. 8.

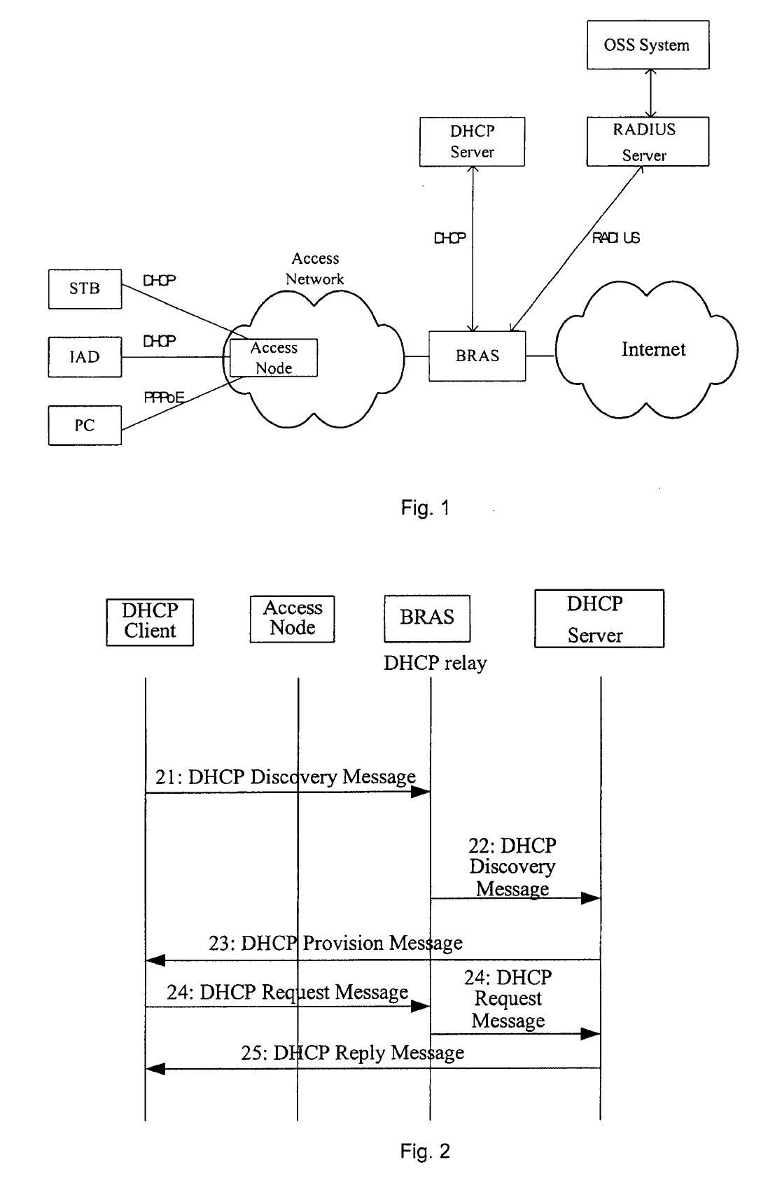

### DETAILED DESCRIPTION OF THE EMBODIMENTS

The main concept of the present invention lies in that: during the process in which a DHCP client obtains an address from a DHCP server, a validity authentication process on the DHCP client is added, so that an invalid subscriber may be prevented from attacking the DHCP server. In addition, based on the above concept, the address management of the DHCP server and the authentication server may be united, thus it is easy to perform address management. The authentication server includes an AAA server such as a RADIUS server. Optionally, the authentication server may be other authentication servers with the similar function.

One embodiment of the present invention provides a method for realizing a secure assignment of a DHCP address, mainly including the following.

(1) A DHCP client sends a DHCP Discovery message via an access network.

(2) The access server on the network side (such as BRAS and access node) determines identification information of the DHCP client, such as the port number, VPI (Virtual path identifiers)/VCI (Virtual channel identifiers) and VLAN ID (Virtual Local Area Network ID), according to ingress port information of the DHCP Discovery message, and performs an authentication to the DHCP client based on the identification information of the DHCP client and preconfigured identification information for a valid subscriber.

Specifically, taking the RADIUS server as an example, the access node or the access server in the access network initiates an authentication request to the RADIUS server according to the identification information of the client, and the RADIUS server performs a validity authentication to the client according to the identification information saved for the valid subscribers.

Optionally, a gateway specialized for an authentication may also be configured. The gateway performs a corresponding authentication according to configured information.

(3) The DHCP Discovery message of the DHCP client having passed the authentication is sent to the DHCP server, and the address is assigned to the DHCP client via the DHCP server. The specific address assignment process is the same as a conventional address assignment process, and the repeat description thereof is omitted.

Moreover, a corresponding DHCP server with an authentication function may be configured in the network, so that the DHCP server may first perform an authentication process after receiving a DHCP Discovery message sent from a DHCP client, and the corresponding address will only be assigned after the authentication is passed.

The present invention provides two kinds of DHCP authentication servers with the authentication function. Descriptions of the DHCP authentication servers will now be illustrated in conjunction with the drawings respectively.

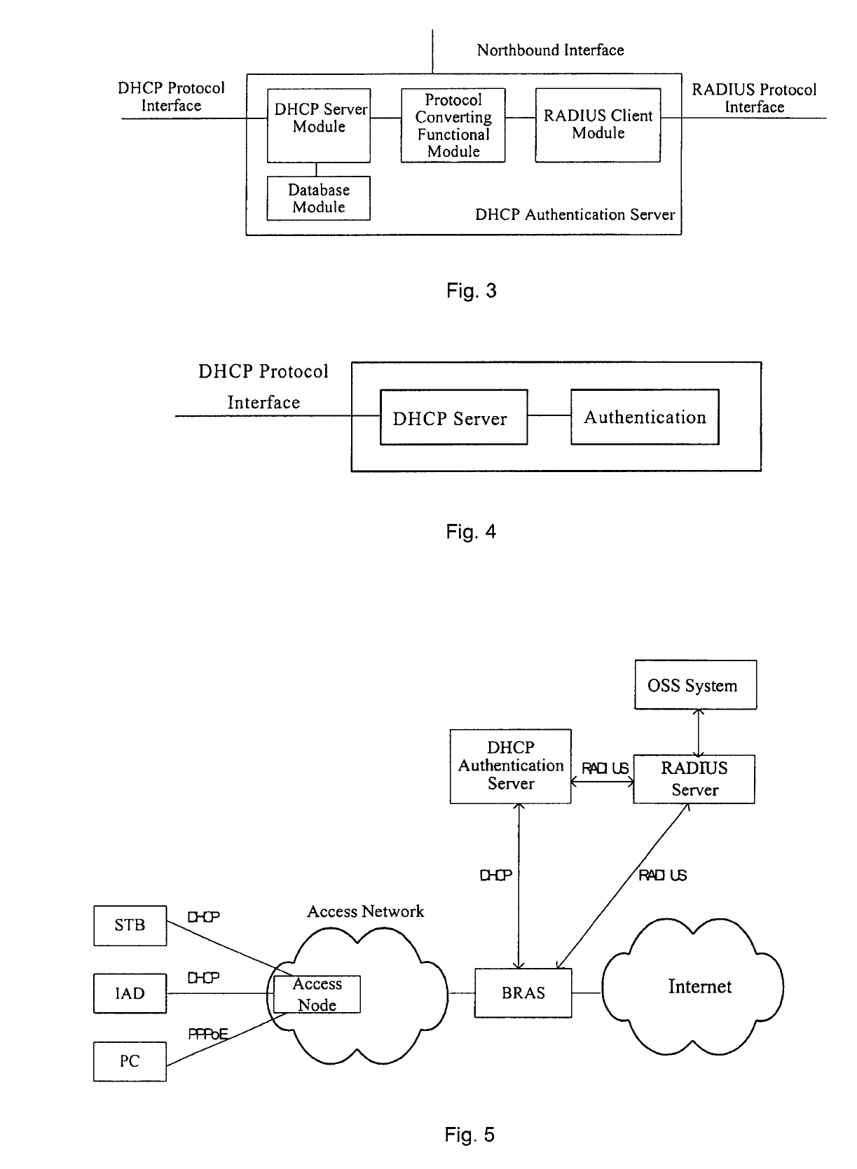

For the first kind of DHCP authentication server with the authentication function, the authentication for the DHCP client is implemented by an authentication server, such as the RADIUS server. The specific structure of the DHCP authentication server is as shown in FIG. 3. With the RADIUS server in FIG. 3 as an example, the DHCP authentication server specifically includes a DHCP server module, a protocol converting module and an RADIUS client module.

The DHCP server module is adapted to assign an IP address to the DHCP client has passed the authentication. Specifically, a DHCP request message sent by a DHCP client via an access node or an access server is received, and corresponding IP address is assigned to the DHCP client by the DHCP server module, wherein the IP address is returned by the RADIUS server for the client has passed the authentication and received by the RADIUS client module.

The protocol converting module is adapted to obtain the information needed by the RADIUS authentication from the DHCP Discovery message of corresponding DHCP client sent from the access node or the access server, and generate a RADIUS authentication message for performing the authentication to the DHCP client. The protocol converting module also needs to respond to the DHCP client according to an authentication response message received by the RADIUS client module. Specifically, for the response message of the DHCP client has passed the authentication, the protocol converting module needs to generate a corresponding DHCP Offer message and send the corresponding DHCP Offer message to the corresponding DHCP client to indicate that the corresponding IP address may be assigned to the DHCP client.

The RADIUS client module is adapted to communicate with the RADIUS server based on the authentication message generated by the DHCP protocol converting module, so that the authentication process on a DHCP client is implemented. Specifically, the validity authentication may be performed according to the authentication rule configured in the RADIUS server, thus the authentication result on the DHCP client is obtained. The authentication result includes the IP address assigned to the client by the RADIUS server and needing to be delivered to the DHCP server module. And the response message of the DHCP client has passed the authentication needs to be delivered to the protocol converting module for further processing, in other words, a DHCP Offer message is sent to the DHCP client.

At this time, the DHCP authentication server operates in a gateway mode, and supports DHCP protocol and RADIUS protocol. In terms of the DHCP client and the BRAS, the DHCP authentication server is the DHCP server, while in terms of the RADIUS server, the DHCP authentication server is the RADIUS client.

The specific process is as follows. The DHCP authentication server processes a DHCP message forwarded via a DHCP relay and generates an RADIUS message to initiate an authentication to the RADIUS server according to the identification information of the client carried in the message. The RADIUS server determines the validity of the subscriber according to preconfigured subscriber data to complete the authentication and assigning an IP address to the subscriber. The DHCP authentication server returns a DHCP message carrying the IP address assigned by the RADIUS to the DHCP client after receiving the authentication response message from the RADIUS server. Thus, the DHCP client obtains the IP address.

For the second kind of DHCP authentication server with the authentication function, the authentication function is configured and implemented locally. The specific structure of the DHCP authentication server is as shown in FIG. 4, including an authentication processing module and a DHCP server module.

The authentication processing module is adapted to obtain the identification information of the DHCP client during initiating the DHCP process, perform a validity authentication to the client according to the identification information saved for valid subscribers, and then send an authentication result to the DHCP server module, wherein the identification information of the valid subscriber is saved in a corresponding storage module (not shown).

The DHCP server module is adapted to obtain the authentication result on the DHCP client from the authentication processing module, send a DHCP Offer message to the DHCP client with the authentication result of PASSED to indicate that the DHCP server may assign a corresponding IP address to the DHCP client, and then assign the corresponding IP address to the DHCP client after the DHCP client sends a DHCP request message. Thus, the function of the DHCP server is implemented.

At this point, the DHCP authentication server operates in a server mode, corresponds to a DHCP server with a secure authentication function, and may implement the authentication and address assignment for a client independently.

The above two kinds of DHCP authentication servers with the authentication function may be configured in any network in need of a DHCP server to realize the corresponding function of address assignment.

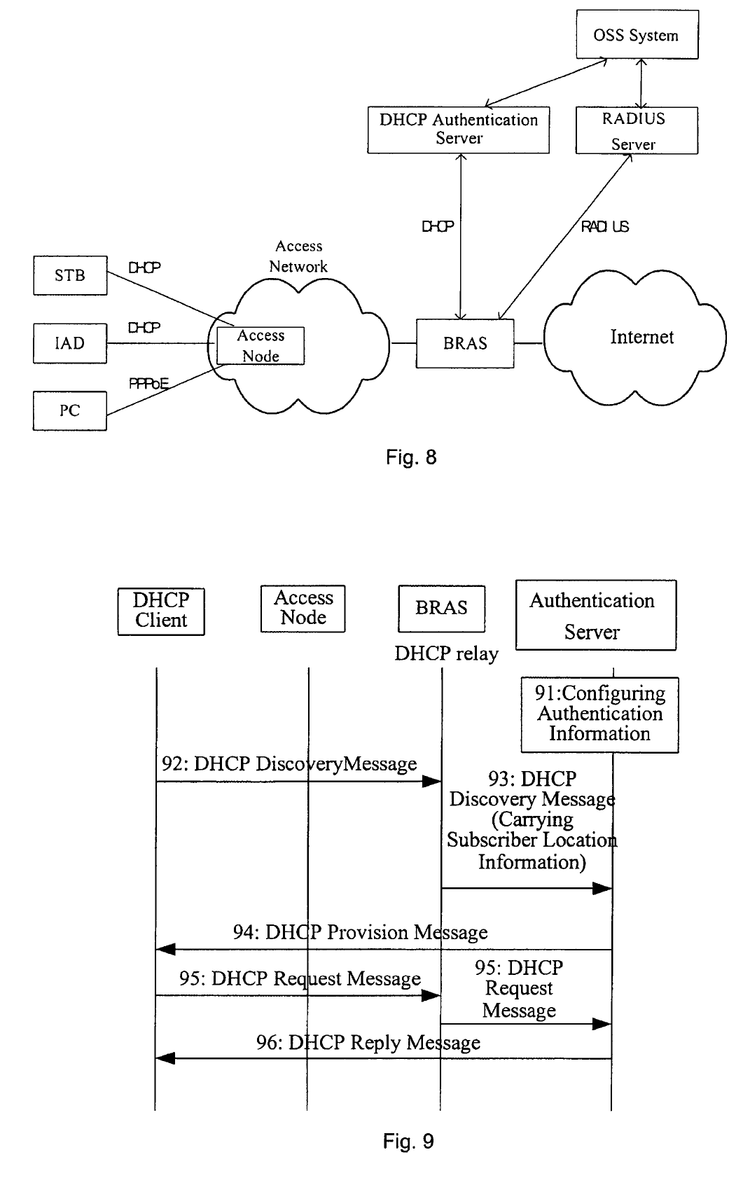

The present invention further provides a corresponding system with a DHCP address assignment and authentication function for realizing a secure assignment of a DHCP address. The structure of the system is shown in FIG. 5 and FIG. 8 respectively, specifically including a DHCP client, an access network and a DHCP authentication server. The DHCP authentication server is adapted to perform a validity authentication to a DHCP Discovery message of the DHCP client obtained by the access network, and perform an address assignment to the DHCP client has passed the authentication.

In the system according to the present invention, the DHCP authentication server may perform the authentication to the DHCP client and assign a corresponding IP address in the following two modes.

Mode 1: As shown in FIG. 5, the identification information of the DHCP client is sent to the RADIUS server in an authentication request message. The RADIUS server performs an authentication and assigns the corresponding IP address to the DHCP client, or the RADIUS server only performs the authentication and the corresponding IP address will be assigned by the DHCP server. Herein, the specific application of the present invention is only described by taking the RADIUS server as the authentication server, but the present invention is not limited hereto.

Mode 2: As shown in FIG. 8, the validity authentication is performed on the identification information of the DHCP client according to the identification information of the valid subscriber saved locally, and the DHCP server may assign the corresponding IP address to the DHCP client has passed the authentication.

Specifically, in the system, the access node and BRAS support the capture of a DHCP message and insert an option Option82 into the DHCP message, so that the DHCP authentication server may obtain the corresponding identification information of the DHCP client after receiving the DHCP message. In the option Option82, subscriber location information, acting as the identification information, is identified. Specifically, the subscriber location information includes port information, VPI/VCI information and VLAN ID. The option Option82 may be inserted into the DHCP message on the access node, or the option Option82 may be inserted into the DHCP message on the BRAS.

The present invention further provides a corresponding method for realizing a secure assignment of a DHCP address based on the above system. A detail description will now be illustrated below.

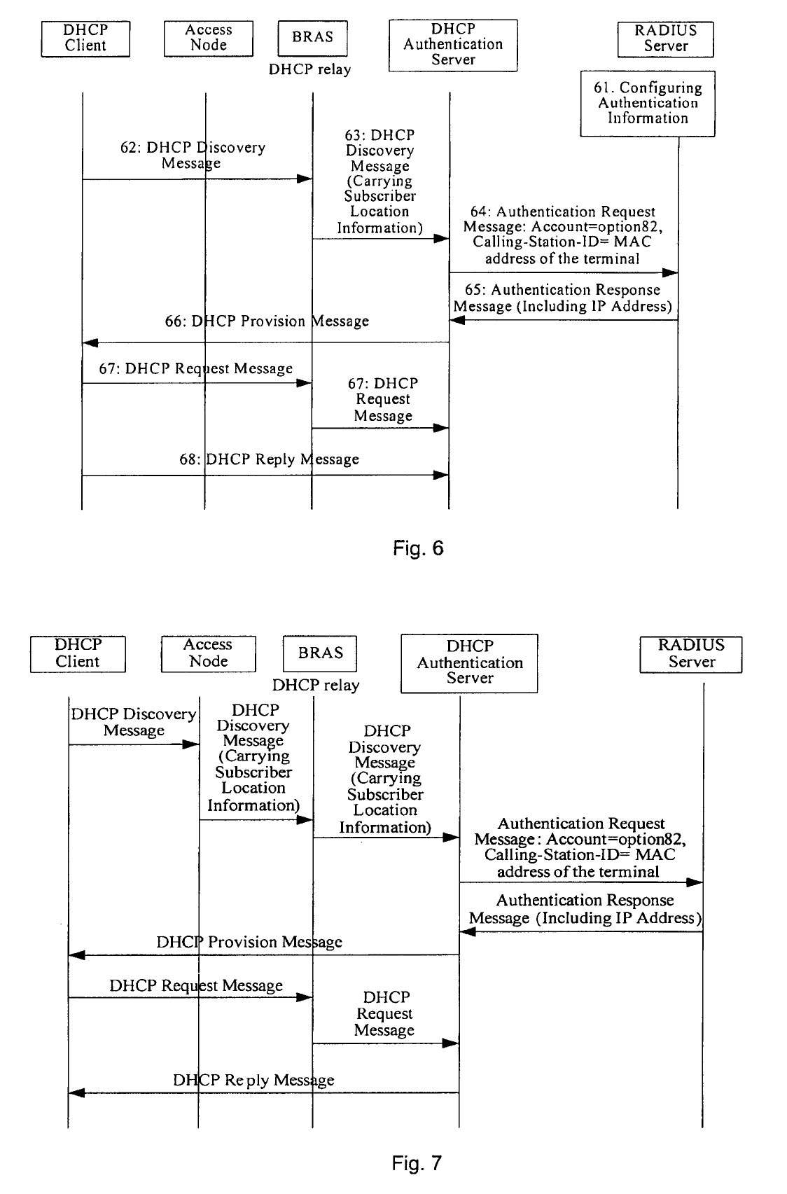

Firstly, for example, the method will be illustrated when the DHCP authentication server operates in the gateway mode and the authentication server is the RADIUS server. Specifically, the method is shown in FIG. 5, FIG. 6 and FIG. 7.

As shown in FIG. 5 and FIG. 6, the method includes the following steps.

Step 61: When a subscriber opens an account, the operator adds a piece of subscriber data to an RADIUS server. The account is the subscriber location information, the encoding mode is consistent with the option Option82 inserted by the access node or the BRAS, and the MAC (Media Access Control) address of a terminal (STB, IAD) may be selectively recorded.

Step 62: When the DHCP client needs to obtain the IP address, the DHCP client needs to send a DHCP Discovery message to the BRAS.

Step 63: As a DHCP relay, the BRAS captures the DHCP message and inserts option Option82 into the message, and then sends the DHCP Discovery message carrying the subscriber location information to the DHCP authentication server. The subscriber location information, such as port information, VPI/VCI and VLAN ID, is identified in the option Option82.

Step 64: The DHCP authentication server receives the DHCP message relayed by the BRAS, extracts the option Option82 and the MAC address of the terminal, generates an RADIUS protocol message and sends the RADIUS protocol message to the RADIUS server, wherein the account in the message is the content of option82, and the attribute of Calling-Station-ID in the message is the MAC address of the terminal.

The RADIUS server receives the authentication request and performs the authentication according to information in a database, and determines the validity of the subscriber according to the account. Moreover, the RADIUS server may determine the validity of the terminal according to the MAC address. If the authentication is passed, an IP address is assigned to the subscriber, and an authentication response message is returned, as described in Step 65.

Step 65: After the authentication is passed, the RADIUS server returns an authentication response message carrying the IP address assigned to the client, to the DHCP authentication server.

After the DHCP authentication server receives the authentication response message, the DHCP authentication server extracts the IP address assigned by the RADIUS, and assigns an IP address to the DHCP client with a standard DHCP process, as described in subsequent steps.

Step 66: After the DHCP authentication server receives the response message, the DHCP authentication server sends a DHCP Offer message to the DHCP client.

Step 67: After the DHCP client receives the DHCP Offer message, the DHCP client sends a DHCP request message to the DHCP authentication server.

Step 68: The DHCP authentication server sends the IP address sent from the RADIUS server to the DHCP client via a DHCP Reply message.

In the above Step 63, the process in which BRAS inserts the option Option82 is described. In practical application, as shown in FIG. 7, the option Option82 may be inserted by DSLAM, in other words, by the access node, while the BRAS only acts as a DHCP relay. Other processes are the same as those described above.

In the above process, if the RADIUS server only performs the authentication and the DHCP server assigns corresponding IP addresses, the process of Step 65 to Step 68 may be as follows. When the RADIUS server returns an authentication pass message to the DHCP server, the DHCP server sends a DHCP Offer message to the DHCP client, and a corresponding IP address will be assigned to the DHCP client subsequently with the conventional address assignment process.

Subsequently, for example, the method is described in the case that the DHCP authentication server operates in a server mode, as shown in FIG. 8 and FIG. 9.

Step 91: When a subscriber opens an account, the operator adds a piece of data to a DHCP authentication server and records the subscriber location information, the encoding mode is consistent with the option Option82 inserted by the access node or the BRAS, and the MAC address of a terminal (STB, IAD) may be selectively recorded.

Step 92: When a DHCP client needs to obtain the IP address, the DHCP client needs to send a DHCP Discovery message to the BRAS.

Step 93: As a DHCP relay, the BRAS captures the DHCP message and inserts option Option82 into the message, and then sends the DHCP Discovery message carrying the subscriber location information to the DHCP authentication server. The subscriber location information, such as port information, VPI/VCI and VLAN ID, is identified in the option Option82.

The DHCP authentication server receives the DHCP message relayed by the BRAS, extracts the option Option82 and the MAC address of the terminal as the identification information, queries a local database, and performs an authentication to the identification information of the DHCP client according to the identification information saved for a valid subscriber locally. If the authentication is passed, the DHCP authentication server returns a DHCP Offer message to the DHCP client, as described in Step 94.

Step 94: The DHCP authentication server sends a DHCP Offer message to the DHCP client.

Step 95: After receiving the DHCP Offer message, the DHCP client sends a DHCP request message to the DHCP authentication server.

Step 96: The DHCP authentication server assigns the IP address to the DHCP client, and sends the IP address to the DHCP client via a DHCP Reply message.

Similarly, as described in Step 93 of FIG. 9, the BRAS inserts the option Option82. In practical application, the option Option82 may also be inserted by an access node like DSLAM, while the BRAS only acts as the DHCP relay. Other processes are the same as those described above.

In conclusion, the present invention may enhance the security of the address assignment in DHCP mode greatly, and may perform an access authentication to a subscriber according to location information, and may only assign an IP address to a valid subscriber or a valid terminal. Therefore, the attack of malicious address use-up may be effectively prevented. Moreover, when the network attack or other network security problems occur, the physical location of the subscriber may be traced according to the IP address, so that a hacker may be effectively deterred from carrying out an attack activity.

Additional advantages and modifications will readily occur to those skilled in the art. Therefore, the present invention in its broader aspects is not limited to the specific details and representative embodiments shown and described herein. Accordingly, various modifications and variations may be made without departing from the spirit or scope of the present invention as defined by the appended claims and their equivalents.

1. A method for realizing a secure assignment of a DHCP address, comprising:
sending, by a DHCP client, a DHCP Discovery message via an access network;
obtaining, by an access network side, identification information of the DHCP client and performing an authentication to the DHCP client based on the identification information; and
assigning, by a DHCP server, an address to the DHCP client has passed the authentication.

2. The method for realizing the secure assignment of the DHCP address according to claim 1, wherein, the identification information comprises:
a port number, a circuit number and a connection number of the DHCP client.

3. The method for realizing the secure assignment of the DHCP address according to claim 1, wherein, obtaining, by the access network side, identification information of the DHCP client and performing the authentication to the DHCP client based on the identification information comprises:
determining, by an access node or an access server in the access network, the identification information of the DHCP client according to at least one of an ingress port, a circuit information and connection information of the DHCP Discovery message.

4. The method for realizing the secure assignment of the DHCP address according to claim 1, wherein, obtaining, by the access network side, identification information of the DHCP client and performing the authentication to the DHCP client based on the identification information comprises:
performing, by the access node or the access server in the access network, a validity authentication to the DHCP client according to the identification information of the DHCP client and preconfigured identification information for a valid subscriber.

5. The method for realizing the secure assignment of the DHCP address according to claim 1, wherein, obtaining, by the access network side, identification information of the DHCP client and performing the authentication to the DHCP client based on the identification information comprises:
initiating, by the access node or the access server in the access network, an authentication request to an authentication server using the identification information of the client; and
performing, by the authentication server, the validity authentication to the client according to the identification information saved for a valid subscriber.

6. A DHCP authentication server for realizing a secure assignment of a DHCP address, comprising a DHCP server module, a protocol converting module and an AAA (Authentication, Authorization and Accounting) client module, wherein:
the DHCP server module is adapted to receive a DHCP request message sent by a DHCP client via an access node or an access server and respond to the DHCP client with an address assigned to the DHCP client has passed an authentication, the address is returned by an AAA server and received by an AAA client module;
the protocol converting module is adapted to obtain information needed in AAA authentication in a DHCP Discovery message of a corresponding DHCP client sent from the access node or the access server, generate an MA authentication message, generate a DHCP Offer message according to an authentication response message received by the AAA client module and send the DHCP Offer message; and
the AAA client module is adapted to communicate with the AAA server based on the AAA authentication message generated by the DHCP protocol converting module, obtain an authentication result of the DHCP client, and deliver the authentication result to the protocol converting module and the DHCP server module.

7. A DHCP authentication server for realizing a secure assignment of a DHCP address, comprising an authentication processing module and a DHCP server, wherein:
the authentication processing module is adapted to obtain identification information of a client initiating a DHCP process, perform a validity authentication to the client according to identification information saved for a valid subscriber, and send a DHCP Discovery message of a DHCP client has passed the validity authentication to the DHCP server; and
the DHCP server is adapted to receive the DHCP Discovery message sent by the authentication processing module and send a DHCP Offer message to the DHCP client, and assign an address to a corresponding DHCP client in an address pool of the DHCP server when the DHCP client sends a DHCP request message.

8. A system for realizing a secure assignment of a DHCP address, comprising a DHCP client, an access network and a DHCP authentication server; wherein a DHCP client is adapted to communicate with the DHCP authentication server via an access network to obtain an address; the DHCP authentication server is adapted to perform a validity authentication to a DHCP Discovery message of the DHCP client obtained by the access network, and assign the address to the DHCP client has passed the validity authentication.

9. The method for realizing the secure assignment of the DHCP address according to claim 1, further comprises:
receiving, by an access node or an access server, the DHCP Discovery message sent from the DHCP client, and inserting identification information of the DHCP client into the DHCP Discovery message and sending the DHCP Discovery message to a DHCP authentication server;
obtaining, by the DHCP authentication server, the identification information of the client from the DHCP Discovery message; and
performing, by the DHCP authentication server, a validity authentication to the client using the identification information, and only performing an address assignment process on the DHCP client has passed the validity authentication.

10. The method for realizing the secure assignment of the DHCP address according to claim 9, further comprises:
performing, by the DHCP authentication server, the DHCP authentication for the DHCP client locally according to identification information saved for a valid subscriber, and sending the DHCP Discovery message of the client has passed the DHCP authentication to a DHCP server; and performing, by the DHCP server, the address assignment process.

11. The method for realizing the secure assignment of the DHCP address according to claim 1, further comprising:
receiving, by an access node or an access server, the DHCP Discovery message sent from the DHCP client, and inserting identification information of the DHCP client into the DHCP Discovery message and sending the DHCP Discovery message to a DHCP authentication server;
obtaining, by the DHCP authentication server, the identification information of the DHCP client from the DHCP Discovery message;
sending, by the DHCP authentication server, an authentication request message to an AAA server using the identification information, and performing, by the AAA server, an authentication to the identification information of the DHCP client and assigning an address to the DHCP client has passed the authentication;
or,
sending, by the DHCP authentication server, the authentication request message to the AAA server using the identification information, and performing, by the AAA server, an authentication to the identification information of the DHCP client; assigning, by the DHCP authentication server, the address to the client has passed the authentication after receiving an authentication pass information.

12. The method for realizing the secure assignment of the DHCP address according to claim 2, wherein, obtaining, by the access network side, identification information of the DHCP client and performing the authentication to the DHCP client based on the identification information comprises:
performing, by the access node or the access server in the access network, a validity authentication to the DHCP client according to the identification information of the DHCP client and preconfigured identification information for a valid subscriber.

13. The method for realizing the secure assignment of the DHCP address according to claim 3, wherein, obtaining, by the access network side, identification information of the DHCP client and performing the authentication to the DHCP client based on the identification information comprises:
performing, by the access node or the access server in the access network, a validity authentication to the DHCP client according to the identification information of the DHCP client and preconfigured identification information for a valid subscriber.

14. The method for realizing the secure assignment of the DHCP address according to claim 2, wherein, obtaining, by the access network side, identification information of the DHCP client and performing the authentication to the DHCP client based on the identification information comprises:
initiating, by the access node or the access server in the access network, an authentication request to an authentication server using the identification information of the client; and
performing, by the authentication server, the validity authentication to the client according to the identification information saved for a valid subscriber.

15. The method for realizing the secure assignment of the DHCP address according to claim 3, wherein, obtaining, by the access network side, identification information of the DHCP client and performing the authentication to the DHCP client based on the identification information comprises:
initiating, by the access node or the access server in the access network, an authentication request to an authentication server using the identification information of the client; and
performing, by the authentication server, the validity authentication to the client according to the identification information saved for a valid subscriber.
